(19) United States
(12) Patent Application Publication
(10) Pub. No.: US 2022/0088677 A1
(43) Pub. Date: Mar. 24, 2022

(54) TUBE, METHOD OF MANUFACTURING TUBE, AND RELATED DEVICES

(71) Applicant: KANTHAL AB, Hallstahammar (SE)

(72) Inventors: Thomas LEWIN, Hallstahammar (SE); Pengcheng CAO, Hallstahammar (SE)

(73) Assignee: KANTHAL AB, Hallstahammar (SE)

(21) Appl. No.: 17/420,490

(22) PCT Filed: Feb. 4, 2020
(86) PCT No.: PCT/EP2020/052669

§ 371 Date: Jul. 2, 2021

(30) Foreign Application Priority Data
Feb. 4, 2019 (SE) 1900017-3

(51) Int. Cl. B22F 5/10; B22F 10/85; B33Y 10/00; B33Y 80/00; F16L 43/00

(52) U.S. Cl. CPC B22F 5/106; B22F 10/85; F16L 43/001; B33Y 80/00; B33Y 10/00

(57) ABSTRACT

A tube is disclosed comprising an inlet portion, an outlet portion, and a curved tube portion between the inlet and outlet portions. A vertical cross-section of the curved tube portion comprises two substantially straight inner delimiting surfaces meeting each other at an angle <100°. The present disclosure further relates to a method of manufacturing a tube, a computer program, and a computer-readable medium.

### TECHNICAL FIELD

The present disclosure relates to a method of manufacturing a tube. The present disclosure further relates to a computer program, a computer-readable medium, and a tube for conducting a fluid.

### BACKGROUND

Additive manufacturing, sometime referred to as 3D printing, is any of various processes in which material is joined or solidified under computer control to create a three-dimensional object. The material is typically added together layer by layer such as liquid molecules or powder grains being fused together. There are many different types of additive manufacturing processes that can be grouped into the categories such as material jetting, binder jetting, powder bed fusion, material extrusion, directed energy deposition, and sheet lamination. The term “3D printing” originally referred to a process in which a binder material is deposited onto a powder bed with inkjet printer heads layer by layer. More recently, the term is being used to encompass a wider variety of additive manufacturing techniques.

Additive manufacturing methods provide many advantages, such as the ability to rapidly manufacture an object with a complex shape or geometry. However, some shapes and geometries are difficult to manufacture with a desired result. Common methods to overcome the issues faced when manufacturing objects having such a shape or geometry are to increase cooling speed, slowing down printing speed, or adding one or more support structures. However, such approaches are difficult to control and normally result in poor quality or low productivity. Moreover, when adding a support structure inside an object, it can be difficult to remove the support structure from the object without damaging the object and can be difficult to treat the surface after a potential removal. Furthermore, if leaving a support structure without removal, the support structure can result in a change of the functionality and in the appearance of the object.

In addition, generally, on today's consumer market, it is an advantage if products comprise different features and functions while the products have conditions and/or characteristics suitable for being manufactured in a cost-efficient manner.

### SUMMARY

It is an object of the present disclosure to overcome, or at least alleviate, at least some of the above-mentioned problems and drawbacks.

According to a first aspect of the disclosure, the object is achieved by a method of manufacturing a tube. The method comprises the steps of:
successively depositing first layers of a material such that the deposited first layers together form a first tube half of a first tube portion of the tube, and
successively depositing second layers of a material such that the deposited second layers together form a second tube half of the first tube portion,
   and wherein the second layers are deposited such that the second tube half obtains two substantially straight inner delimiting surfaces meeting each other at an angle less than 100°.

The method provides conditions for reducing or circumventing the need for using support structures during manufacturing of the tube, i.e. when performing the method since the second layers are deposited such that the second tube half obtains two substantially straight inner delimiting surfaces meeting each other at an angle less than 100°. Moreover, a method of manufacturing a tube is provided reducing or circumventing the need for increasing cooling speed and the need for slowing down manufacturing speed because the two substantially straight inner delimiting surfaces potentially reduce overhang of the inner delimiting surfaces of the tube during manufacturing of the tube.

Since the need for using support structures during manufacturing of the tube is reduced or circumvented, a method is provided which is reducing or circumventing the need for removing a support structure from the tube and reducing or circumventing the need for treating the inner surfaces of the tube after a removal of a support structure.

Furthermore, since the need for increasing cooling speed and the need for slowing down manufacturing speed are reduced or circumvented, a method is provided which will have conditions for manufacturing a tube in a quick and cost-efficient manner.

Accordingly, a method is provided overcoming, or at least alleviating, at least some of the above-mentioned problems and drawbacks. As a result, the above-mentioned object is achieved.

According to one embodiment of the method as defined hereinabove or hereinafter, the steps of successively depositing first and second layers of the material comprises the step of:
depositing the first and second layers of the material in a deposition direction,
   and wherein the step of successively depositing second layers of the material comprises the step of:
depositing the second layers of the material such that the bisection of the angle between the two substantially straight inner delimiting surfaces is substantially parallel to the deposition direction.

Hence, a method is provided which further reduces or circumvents the need for using support structures during manufacturing of the tube. Moreover, a method of manufacturing a tube is provided further reducing or circumventing the need for increasing cooling speed and the need for slowing down manufacturing speed because the method comprises the step of depositing the second layers of the material such that the bisection of the angle between the two substantially straight inner delimiting surfaces is substantially parallel to the deposition direction. Due to these features, a stable and rigid second tube half is provided having conditions for obtaining a low degree of overhang of the inner delimiting surfaces of the tube during manufacturing of the tube.

Since the need for using support structures during manufacturing of the tube is further reduced or circumvented, a method is provided further reducing or circumventing the need for removing a support structure from the tube and further reducing or circumventing the need for treating the inner surfaces of the tube after a removal of a support structure.

Moreover, since the need for increasing cooling speed and the need for slowing down manufacturing speed are further reduced or circumvented, a method is provided having conditions for manufacturing a tube in a quicker and more cost-efficient manner.

According to one embodiment of the method as defined hereinabove or hereinafter, the step of depositing the first and second layers of the material in the deposition direction comprises the step of:
depositing the first and second layers of the material in a deposition direction substantially coinciding with a local gravity vector.

Thereby, the method provided reduces or circumvents the need for using support structures during manufacturing of the tube. Moreover, a method of manufacturing a tube is provided further reducing or circumventing the need for increasing cooling speed and the need for slowing down manufacturing speed because the method comprises the step of depositing the first and second layers of the material in a deposition direction substantially coinciding with a local gravity vector. As a result thereof, a stable and rigid second tube half is provided having conditions for obtaining a low degree of overhang of the inner delimiting surfaces of the tube during manufacturing of the tube.

Since the need for using support structures during manufacturing of the tube is further reduced or circumvented, a method is provided further reducing or circumventing the need for removing a support structure from the tube and further reducing or circumventing the need for treating the inner surfaces of the tube after a removal of a support structure.

Moreover, since the need for increasing cooling speed and the need for slowing down manufacturing speed are further reduced or circumvented, a method is provided having conditions for manufacturing a tube in a quicker and more cost-efficient manner.

According to one embodiment of the method as defined hereinabove or hereinafter, the step of successively depositing second layers of the material comprises the step of:
successively depositing the second layers of the material such that the angle between the two substantially straight inner delimiting surfaces, is within the range of from 20-100 degrees. According to one embodiment, the range if from 20 to 95 degrees, such as 25 to 95 degrees, such as 30 to 80 degrees, such as 50 to 92 degrees. According to one embodiment, the angle is less than 90 degrees.

Thereby, a method is provided further reducing or circumventing the need for using support structures during manufacturing of the tube. Moreover, a method of manufacturing a tube is provided further reducing or circumventing the need for increasing cooling speed and the need for slowing down manufacturing speed. This because the method comprises the step of successively depositing the second layers of the material such that the angle between the two substantially straight inner delimiting surfaces, is as defined above. As a result thereof, a stable and rigid second tube half is provided having conditions for obtaining a low degree of overhang of the inner delimiting surfaces of the tube during manufacturing of the tube.

Since the need for using support structures during manufacturing of the tube is further reduced or circumvented, a method is provided further reducing or circumventing the need for removing a support structure from the tube and further reducing or circumventing the need for treating the inner surfaces of the tube after a removal of a support structure.

Moreover, since the need for increasing cooling speed and the need for slowing down manufacturing speed are further reduced or circumvented, a method is provided having conditions for manufacturing a tube in a quicker and more cost-efficient manner.

According to one embodiment of the method as defined hereinabove or hereinafter, the step of successively depositing first layers of the material comprises the step of:
successively depositing the first layers of the material such that the first tube half obtains a substantially arc-shaped inner delimiting surface.

Thereby, the inner surfaces of the tube manufactured by the method will have a low impact on a flow of fluid flowing through the tube, while the method has conditions and characteristics suitable for manufacturing the tube in a quick and cost-efficient manner.

According to one embodiment of the present method, the steps of successively depositing first and second layers of the material comprises the step of:
depositing the first and second layers of the material such that the first tube portion forms a curved tube portion.

Curved tubes are inherently difficult to manufacture using additive manufacturing as it is difficult to avoid large overhangs regardless of the orientation of such a tube. However, since the second layers are deposited such that the second tube half obtains two substantially straight inner delimiting surfaces meeting each other at an angle less than 100°, large overhangs can be avoided during manufacturing of the tube.

Thus, a method is provided capable of manufacturing a curved tube with a reduced or circumvented need for using support structures during manufacturing of the tube. Moreover, a method of manufacturing a curved tube is provided reducing or circumventing the need for increasing cooling speed and the need for slowing down manufacturing speed.

Since the need for using support structures during manufacturing of the curved tube is reduced or circumvented, a method is provided which will reduce or circumvent the need for removing a support structure from the curved tube and reducing or circumventing the need for treating the inner surfaces of the curved tube after a removal of a support structure.

Furthermore, since the need for increasing cooling speed and the need for slowing down manufacturing speed are reduced or circumvented, a method is provided having conditions for manufacturing a curved tube in a quick and cost-efficient manner.

According to another embodiment, the method as defined hereinabove or hereinafter further comprises the step of:
successively depositing third layers of a material such that the deposited third layers form an inlet portion and an outlet portion each attached to the first tube portion.

Thereby, a method is provided capable of manufacturing a curved tube having an inlet and outlet portion in a quick and cost-efficient manner.

According to one embodiment of the method as defined hereinabove or hereinafter, the step of successively depositing third layers of the material comprises the step of:
successively depositing third layers of the material such that each of the inlet and outlet portion, obtains an elliptic, oval, or substantially circular inner delimiting surface.

Hence, the inner surfaces of the tube manufactured by the method will have a low impact on a flow of fluid flowing through the tube, while the method has conditions and characteristics suitable for manufacturing the tube in a quick and cost-efficient manner.

According to one embodiment of the present method, the steps of successively depositing first, second, and third layers of the material comprises the step of:
successively depositing first, second, and third layers of the material such that the tube obtains a substantially constant effective cross-sectional area in a flow path from the inlet portion to the outlet portion.

According to the present disclosure the effective cross-sectional area is the area through which the fluid mainly flows. The nature of a fluid flow is to flow through the easiest path, thus towards directions with the lowest pressure and the effective cross-sectional area is the area within the tube which will have the lowest pressure.

Thereby, the inner surfaces of the tube manufactured by the method will have a low impact on a flow of fluid flowing through the tube, while the method has conditions and characteristics suitable for manufacturing the tube in a quick and cost-efficient manner.

According to one embodiment, the steps of successively depositing first, second, and third layers of the material may comprise the step of:
successively depositing first, second, and third layers of the material such that the angle between a centre axis (C1) of the inlet portion and a centre axis (C2) of the outlet portion is within the range of from 0-100 degrees, such as 0-90 degrees.

According to one embodiment, the centre axis (C1) of the inlet portion and the centre axis (C2) of the outlet portion are parallel. According to another embodiment the centre axis (C1) of the inlet portion and the centre axis (C2) of the outlet portion can have any direction in space.

Thereby, the tube manufactured by the method is provided with a significant curvature. Such tubes are inherently difficult to manufacture using additive manufacturing because it is difficult to avoid large overhangs regardless of the orientation of such a tube. However, since the second layers are deposited such that the second tube half obtains two substantially straight inner delimiting surfaces meeting each other at an angle, large overhangs can be avoided during manufacturing of the tube.

Thus, a method is provided capable of manufacturing a curved tube with a reduced, or circumvented, need for using support structures during manufacturing of the tube. Moreover, a method of manufacturing a curved tube is provided reducing or circumventing the need for increasing cooling speed and the need for slowing down manufacturing speed.

Since the need for using support structures during manufacturing of the curved tube is reduced or circumvented, a method is provided reducing or circumventing the need for removing a support structure from the curved tube and reducing or circumventing the need for treating the inner surfaces of the curved tube after a removal of a support structure.

Furthermore, since the need for increasing cooling speed and the need for slowing down manufacturing speed are reduced or circumvented, a method is provided having conditions for manufacturing a curved tube in a quick and cost-efficient manner.

Optionally, each deposited layer of the material comprises a metallic material, a plastic material or a ceramic material. The tube as defined hereinabove or hereinafter may be composed of the same or different materials.

Thereby, the tube manufactured by the method can be utilized for various purposes, including conduction of high temperature fluids, while the method has conditions and characteristics suitable for manufacturing the tube in a quick and cost-efficient manner.

According to a second aspect of the disclosure, the object is achieved by a computer program comprising instructions which, when the program is executed by a computer of an additive manufacturing machine, cause the additive manufacturing machine to carry out the method according to some embodiments of the present disclosure. Since the computer program comprises instructions which, when the program is executed by a computer, cause the computer to carry out the method according to some embodiments described herein, the computer program provides conditions for reducing or circumventing the need for using support structures during manufacturing of a tube. Moreover, a computer program is provided reducing or circumventing the need for increasing cooling speed and the need for slowing down manufacturing speed because the two substantially straight inner delimiting surfaces of the tube potentially reduce overhang of the inner delimiting surfaces of the tube during manufacturing of the tube.

Since the need for using support structures during manufacturing of the tube is reduced or circumvented, a computer program is provided which is reducing or circumventing the need for removing a support structure from the tube and reducing or circumventing the need for treating the inner surfaces of the tube after a removal of a support structure.

Furthermore, since the need for increasing cooling speed and the need for slowing down manufacturing speed are reduced or circumvented, the computer program provides conditions for manufacturing a tube in a quick and cost-efficient manner.

Accordingly, a computer program is provided overcoming, or at least alleviating, at least some of the above-mentioned drawbacks. As a result, the above-mentioned object is achieved.

According to a third aspect of the disclosure, the object is achieved by a computer-readable medium comprising instructions which, when executed by a computer of an additive manufacturing machine, cause the additive manufacturing machine to carry out the method according to some embodiments of the present disclosure. Since the computer-readable medium comprises instructions which, when the program is executed by a computer, cause the computer to carry out the method according to some embodiments described herein, a computer-readable medium is provided which provides conditions for overcoming, or at least alleviating, at least some of the above-mentioned drawbacks. As a result, the above-mentioned object is achieved.

According to a fourth aspect of the disclosure, the object is achieved by a tube for conducting a fluid. The tube comprises an inlet portion, an outlet portion, and a curved tube portion between the inlet and outlet portions, wherein a vertical cross-section of the curved tube portion comprises two substantially straight inner delimiting surfaces meeting each other at an angle less than 100°.

Curved tubes are inherently difficult to manufacture using additive manufacturing because it is difficult to avoid large overhangs regardless of the orientation of such a tube. However, since the vertical cross-section of the curved tube portion comprises two substantially straight inner delimiting surfaces meeting each other at an angle less than 100°, large overhangs can be avoided during manufacturing of the tube using additive manufacturing.

Moreover, since the vertical cross-section of the curved tube portion comprises two substantially straight inner delimiting surfaces meeting each other at an angle less than 100°, the need for using support structures during manufacturing of the tube is reduced, or circumvented, when manufacturing the tube using additive manufacturing. Furthermore, since the vertical cross-section of the curved tube portion comprises two substantially straight inner delimiting surfaces meeting each other at an angle less than 100°, the need for increasing cooling speed and the need for slowing down manufacturing speed is reduced, or circumvented, when manufacturing the tube using additive manufacturing. This because the two substantially straight inner delimiting surfaces potentially reduce overhang of the inner delimiting surfaces of the tube during manufacturing of the tube using additive manufacturing.

Accordingly, a tube is provided reducing or circumventing the need for removing a support structure from the tube and reducing or circumventing the need for treating the inner surfaces of the tube, after a removal of a support structure, in an additive manufacturing process of the tube.

Furthermore, a tube is provided having conditions and characteristics suitable for being manufactured in a quick and cost-efficient manner using additive manufacturing.

Accordingly, a tube is provided overcoming, or at least alleviating, at least some of the above-mentioned problems and drawbacks. As a result, the above-mentioned object is achieved.

Optionally, the bisection of the angle between the two substantially straight inner delimiting surfaces is substantially parallel to a plane extending through the inlet and outlet portions.

Thereby, large overhangs can be avoided when manufacturing the tube using additive manufacturing simply by orienting the tube such that the bisection of the angle and the plane extending through the inlet and outlet portions substantially coincides with a gravity vector at the location of the manufacturing process.

Thus, due to these features, the need for using support structures during manufacturing of the tube is further reduced, or circumvented, when manufacturing the tube using additive manufacturing. Furthermore, the need for increasing cooling speed and the need for slowing down manufacturing speed is further reduced, or circumvented, when manufacturing the tube using additive manufacturing.

Accordingly, a tube is provided reducing or circumventing the need for removing a support structure from the tube and reducing or circumventing the need for treating the inner surfaces of the tube, after a removal of a support structure, in an additive manufacturing process of the tube.

Furthermore, a tube is provided having conditions and characteristics suitable for being manufactured in a quicker and more cost-efficient manner using additive manufacturing.

Optionally, the plane is parallel with the centre axis of the inlet and outlet portions. Thereby, large overhangs can be further avoided when manufacturing the tube using additive manufacturing simply by orienting the tube such that the bisection of the angle and the plane extending through the respective centre axis of the inlet and outlet portions substantially coincides with a gravity vector at the location of the manufacturing process.

Thus, due to these features, the need for using support structures during manufacturing of the tube is further reduced, or circumvented, when manufacturing the tube using additive manufacturing. Furthermore, the need for increasing cooling speed and the need for slowing down manufacturing speed is further reduced, or circumvented, when manufacturing the tube using additive manufacturing.

Accordingly, a tube is provided reducing or circumventing the need for removing a support structure from the tube and reducing or circumventing the need for treating the inner surfaces of the tube, after a removal of a support structure, in an additive manufacturing process of the tube.

Furthermore, a tube is provided having conditions and characteristics suitable for being manufactured in a quicker and more cost-efficient manner using additive manufacturing.

Optionally, the angle between the two substantially straight inner delimiting surfaces is within the range as defined above. Thereby, a tube is provided further reducing or circumventing the need for using support structures during manufacturing of the tube using additive manufacturing. Moreover, a tube is provided further reducing or circumventing the need for increasing cooling speed and the need for slowing down manufacturing speed during manufacturing of the tube using additive manufacturing. This because the angle between the two substantially straight inner delimiting surfaces provides a stable and rigid second tube half having conditions for obtaining a low degree of overhang of the inner delimiting surfaces of the tube during manufacturing of the tube.

Since the need for using support structures during manufacturing of the tube is further reduced or circumvented, a tube is provided further reducing or circumventing the need for removing a support structure from the tube and further reducing or circumventing the need for treating the inner surfaces of the tube after a removal of a support structure, in an additive manufacturing process of the tube.

Moreover, since the need for increasing cooling speed and the need for slowing down manufacturing speed are further reduced or circumvented, a tube is provided having conditions and characteristics suitable for being manufactured in a quicker and more cost-efficient manner using additive manufacturing.

According to one embodiment, in the tube as defined hereinabove or hereinafter, the vertical cross-section of the curved tube portion comprises a substantially arc-shaped inner delimiting surface opposite to the two substantially straight inner delimiting surfaces. Thereby, the inner surfaces of the tube will have a low impact on a flow of fluid flowing through the tube, while the tube has conditions and characteristics suitable for being manufactured in a quick and cost-efficient manner using additive manufacturing.

Optionally, the each of the inlet and outlet portion, comprises an elliptic, oval, or substantially circular inner delimiting surface. Thereby, the inner surfaces of the tube will have a low impact on a flow of fluid flowing through the tube, while the tube has conditions and characteristics suitable for being manufactured in a quick and cost-efficient manner using additive manufacturing.

According to one embodiment, the tube as defined hereinabove or hereinafter comprises a substantially constant effective cross-sectional area in a flow path from the inlet portion to the outlet portion. Thereby, the inner surfaces of the tube will have a low impact on a flow of fluid flowing through the tube, while the tube has conditions and characteristics suitable for being manufactured in a quick and cost-efficient manner using additive manufacturing.

According to one embodiment, the angle between a centre axis of the inlet portion and a centre axis of the outlet portion is within the range of from 0-120 degrees, such as 0-90 degrees, and the tube is thereby provided with a significant curvature. According to one embodiment, the centre axis of the inlet and outlet portions are parallel. According to another embodiment, the centre axis of the inlet and outlet portion may have any direction in space relative each other. Such tubes are inherently difficult to manufacture using additive manufacturing because it is difficult to avoid large overhangs regardless of the orientation of such a tube. However, since the cross-section of the curved tube portion comprises two substantially straight inner delimiting surfaces meeting each other at an angle, large overhangs can be avoided during manufacturing of the tube using additive manufacturing.

Optionally, the tube is formed by a metallic material. Thereby, the tube can be utilized for various purposes, including conduction of high temperature fluids, while the tube has conditions and characteristics suitable for being manufactured in a quick and cost-efficient manner. The tube may also be manufactured from plastic material or from ceramic material. The tube may be composed of the same or different materials.

Further features of, and advantages with, the present disclosure will become apparent when studying the appended claims and the following detailed description.

### BRIEF DESCRIPTION OF THE DRAWINGS

Various aspects of the disclosure, including its particular features and advantages, will be readily understood from the example embodiments discussed in the following detailed description and the accompanying drawings, in which:

FIG. 1 illustrates a perspective view of a tube according to some embodiments,

FIG. 2 illustrates a cross-section through a curved tube portion and a base portion of the tube illustrated in FIG. 1,

FIG. 3 illustrates a second cross-section through the tube illustrated in FIG. 1,

FIG. 4 illustrates a method of manufacturing a tube,

FIG. 5 schematically illustrates an additive manufacturing machine, and

FIG. 6 illustrates a computer-readable medium.

### DETAILED DESCRIPTION

Aspects of the present disclosure will now be described more fully. Like numbers refer to like elements throughout. Well-known functions or constructions will not necessarily be described in detail for brevity and/or clarity.

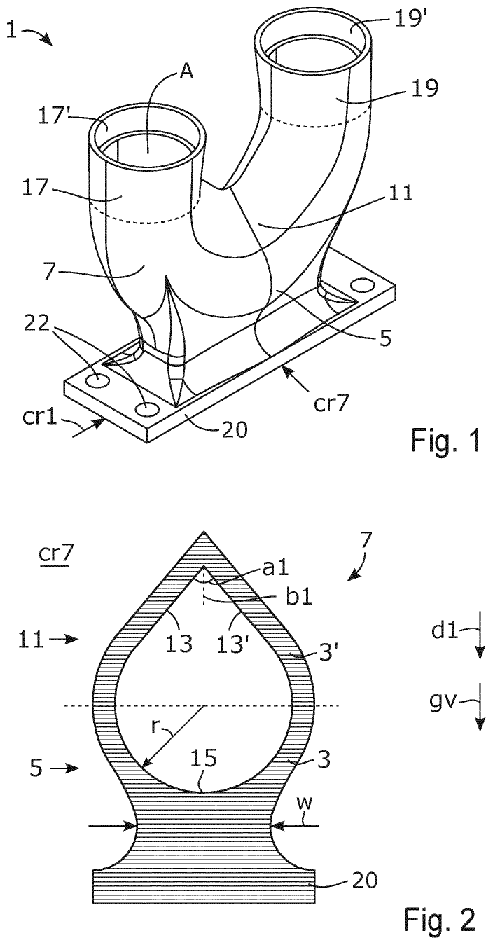

FIG. 1 illustrates a perspective view of a tube 1 according to some embodiments. According to the illustrated embodiments, the tube 1 is configured to conduct a fluid, such as gas or liquid. The tube 1 comprises an inlet portion 17, an outlet portion 19, and a curved tube portion 7 between the inlet and outlet portions 17, 19. The curved tube portion 7 is also referred to as the first tube portion 7 according to some embodiments herein. The tube 1 further comprises a base portion 20 attached to the curved portion 7. The base portion 20 comprises a number of holes 22. Each of the holes 22 is adapted to receive a fastening element so as to fasten the tube 1 to a second structure. As is further explained herein, the tube 1 is adapted to be manufactured using an additive manufacturing method.

FIG. 2 illustrates a vertical cross-section cr7 through the curved tube portion 7 and the base portion 20 of the tube 1 illustrated in FIG. 1. The location of the vertical cross-section cr7 is indicated with an arrow “cr7” in FIG. 1. The vertical cross-section cr7 is perpendicular to an intended flow direction through the tube 1. Below, simultaneous reference is made to FIG. 1 and FIG. 2. As can be seen in FIG. 2, the vertical cross-section cr7 of the curved tube portion 7 comprises two substantially straight inner delimiting surfaces 13, 13′ meeting each other at an angle a1 less than 100°. Thereby, as is further explained herein, conditions are provided for manufacturing the tube 1 with a low degree of overhang. Overhang can be defined as an angle in which new material is deposited onto existing material of a component during manufacturing thereof, at a side at which the new material is not supported by the existing material. In FIG. 2, first layers 3 of a material are indicated which are deposited onto each other so as to form a first tube half 5 of the curved tube portion 7 of the tube 1. Moreover, second layers 3′ of a material are indicated which are deposited onto each other so as to form a second tube half 11 of the curved tube portion 7 of the tube 1. The two substantially straight inner delimiting surfaces 13, 13′ are comprised in the second tube half 11 of the curved tube portion 7. As can be seen in FIG. 2, the second layers 3′ of the material, which forms the two substantially straight inner delimiting surfaces 13, 13′, are deposited on top of each other with a low and substantially constant overhang. Due to these features, as is further explained herein, the tube 1 has conditions for being manufactured without using support structures and without increasing cooling speed or slowing down the manufacturing speed.

According to the illustrated embodiments, the angle a1 between the two substantially straight inner delimiting surfaces 13, 13′ is approximately 81 degrees. According to further embodiments, the angle a1 between the two substantially straight inner delimiting surfaces 13, 13′ may be within the range of from 20-100 degrees, According to one embodiment, the range if from 20 to 95 degrees, such as 25 to 95 degrees, such as 30 to 80 degrees, such as 50 to 92 degrees. According to one embodiment, the angle is less than 90 degrees.

Thereby, it can be ensured that the tube 1 can be manufactured with a low degree of overhang.

Moreover, according to the illustrated embodiments, the vertical cross-section cr7 of the curved tube portion 7 comprises a substantially arc-shaped inner delimiting surface 15 opposite to the two substantially straight inner delimiting surfaces 13, 13′. Furthermore, as seen in FIG. 2, the base portion 20 is provided with a minimum width w, measured in the vertical cross-section cr7, being greater than the radius of curvature r of the substantially arc-shaped inner delimiting surface 15. Due to these features, conditions are provided for manufacturing the first tube half 5 of the curved tube portion 7 with a low degree of overhang.

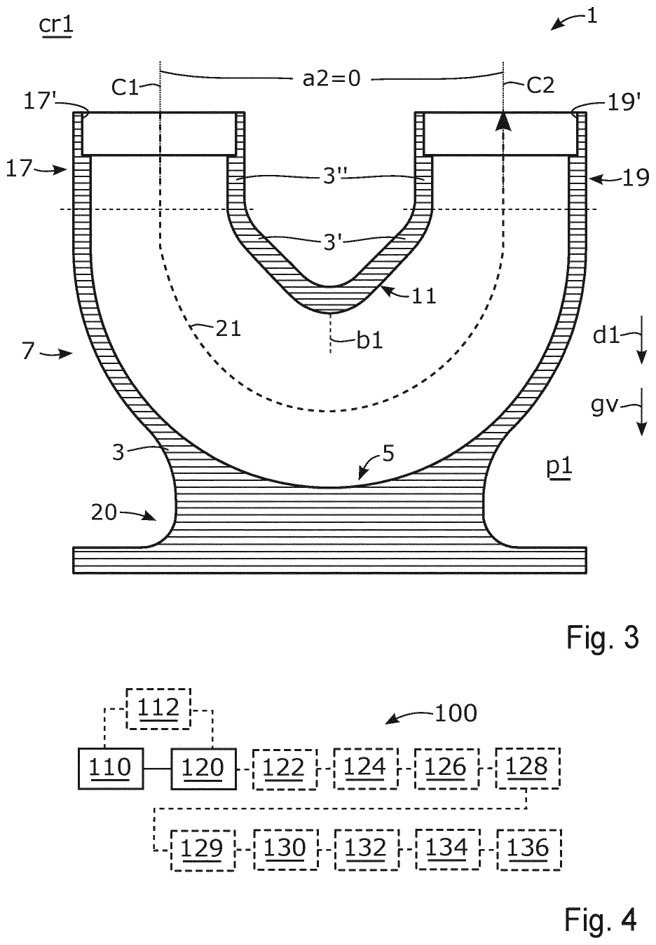

FIG. 3 illustrates a vertical cross-section cr1 through the tube 1 illustrated in FIG. 1. The location of the vertical cross-section cr1 is indicated with an arrow “cr1” in FIG. 1. The vertical cross-section cr1 is made in a plane p1 extending through a respective centre axis C1, C2 of the inlet and outlet portions 17, 19. Moreover, the cross-section cr1 is made straight through a flow path 21 through the tube 1 from the inlet portion 17 to the outlet portion 19.

According to the illustrated embodiments, the angle a2 between the centre axis C1 of the inlet portion 17 and the centre axis C2 of the outlet portion 19 is approximately 0 degrees. Thus, according to the illustrated embodiments, the centre axis C1 of the inlet portion 17 is substantially parallel to the centre axis C2 of the outlet portion 19. As a result thereof, according to the illustrated embodiments, when the tube 1 is used for conducting a fluid, the flow direction at the inlet portion 17 is approximately opposite to the flow direction at the outlet portion 19. With other words, in such embodiments, the angle between the flow direction at the inlet portion 17 and the flow direction at the outlet portion 19 is approximately 180 degrees. According to further embodiments, the angle a2 between the centre axis C1 of the inlet portion 17 and the centre axis C2 of the outlet portion 19 may be within the range of from 0-120 degrees, such as 0-90 degrees, and such as 0-20 degrees. According to further embodiments, the centre axis (C1) of the inlet portion and the centre axis (C2) of the outlet portion are parallel or the centre axis (C1) of the inlet portion and the centre axis (C2) of the outlet portion can have any direction in space.

In FIG. 2, the bisection b1 of the angle a1 between the two substantially straight inner delimiting surfaces 13, 13′ is indicated. The bisection b1 of the angle a1 is also indicated in FIG. 3. As can be seen in FIG. 3, the bisection b1 of the angle a1 between the two substantially straight inner delimiting surfaces 13, 13′ is substantially parallel to a plane p1 extending through the inlet and outlet portions 17, 19. Advantages thereof are explained in the following.

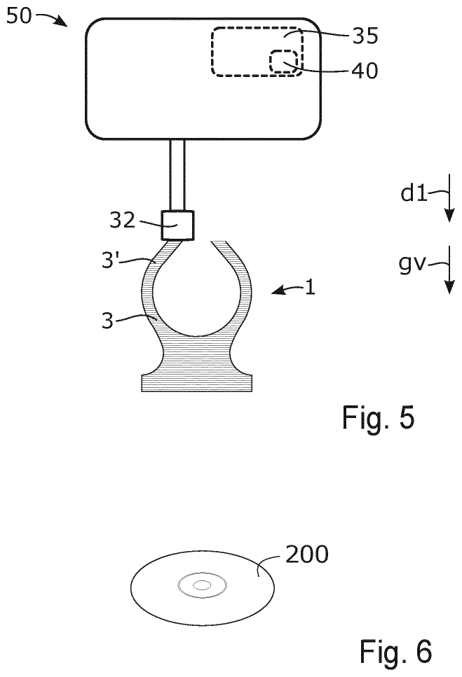

According to the illustrated embodiments, the tube 1 is configured to be manufactured in the upright position illustrated in FIG. 2 and FIG. 3. An additive manufacturing machine may manufacture the tube 1 by successively depositing first layers 3 of a material such that the deposited first layers 3 together form the base portion 20 and the first tube half 5 of the curved tube portion 7 of the tube 1. The additive manufacturing machine may then successively deposit second layers 3′ of a material such that the deposited second layers 3′ together form the second tube half 11 of the curved tube portion 7. Such an additive manufacturing machine 50 is illustrated in FIG. 5, as is further explained below.

As indicated in FIG. 2 and FIG. 3, the first and second layers 3, 3′ of the material are deposited in a deposition direction d1 substantially coinciding with a local gravity vector gv. Moreover, as can be seen in FIG. 2 and FIG. 3, the deposition direction d1 is substantially perpendicular to an extension plane of each layer 3, 3′, 3″. That is, each layer 3, 3′, 3″ is deposited in a deposition direction d1 substantially perpendicular to the extension plane of the layer 3, 3′, 3″ onto which the layer 3, 3′, 3″ is deposited. Thus, because the bisection b1 of the angle a1 between the two substantially straight inner delimiting surfaces 13, 13′ is substantially parallel to the plane p1, a low degree of overhang is provided of each of the two substantially straight inner delimiting surfaces 13, 13′. Moreover, since the angle a2 between a centre axis C1 of the inlet portion 17 and a centre axis C2 of the outlet portion 19 is approximately 0 degrees, and since the centre axes C1, C2 of the inlet and outlet portions 17, 19 extends in directions coinciding with the local gravity vector gv, the inlet portion 17 and the outlet portion 19 can be manufactured with essentially no overhang. In this manner, each of the inlet and outlet portion 17, 19 can for example be provided with an elliptic, oval, or substantially circular inner delimiting surface 17′, 19′ without any overhang during the manufacturing process. According to the illustrated embodiments, each of the inlet and outlet portion 17, 19 comprises a substantially circular inner delimiting surface 17′, 19′, as is best seen in FIG. 1.

A traditional design of U bend round tube has been difficult to be manufactured by Additive Manufacturing (AM). Due to the natural shape of a U bend round tube, it is very difficult to avoid large overhangs regardless of any orientation. Overhang structures with angels greater than 45 degrees along the gravity direction gv normally result in deformation or poor surface, mainly due to gravity force during solidification. The common methods to overcome the overhang issue are increasing cooling speed, slowing down printing speed, or adding support structures. However, such approaches are difficult to control and normally result in poor quality or low productivity. Especially with adding support structures inside U bend round tubes, it will be extremely difficult to remove the support from inside of the U bend and difficult to treat the surface after potential removal. While leaving the support without removal will result in changing the effective profile of the path along the U bend tube, which will cause unwanted pressure changes in certain applications where fluid go through. However, due to the features of the tube 1, the tube 1 can be manufactured using additive manufacturing without using support structures and without increasing cooling speed or slowing down the manufacturing speed.

According to the illustrated embodiments, the tube 1 comprises a substantially constant effective cross-sectional area A in a flow path 21 through the tube 1 from the inlet portion 17 to the outlet portion 19. In this manner, the inner surfaces of the tube 1 will have a low impact on a flow of fluid flowing through the tube 1, while the tube 1 has conditions and characteristics suitable for being manufactured in a quick and cost-efficient manner.

According to some embodiments of the present disclosure, the tube 1 is formed by a metallic material. Thereby, a tube 1 is provided which can be for various purposes, including conduction of high temperature fluids, such as combustion gases, hot exhaust gases, and the like. According to further embodiments, the tube 1 may be manufactured from another type of material, such as a polymeric material or a ceramic material.

FIG. 4 illustrates a method 100 of manufacturing a tube. The tube may be a tube 1 according to the embodiments illustrated in FIG. 1-FIG. 3. Therefore, below, simultaneous reference is made to FIG. 1-FIG. 4. The method 100 of manufacturing a tube 1 comprises the steps of:
successively depositing 110 first layers 3 of a material such that the deposited first layers 3 together form a first tube half 5 of a first tube portion 7 of the tube 1, and
successively depositing 120 second layers 3′ of a material such that the deposited second layers 3′ together form a second tube half 11 of the first tube portion 7,
and wherein the second layers 3′ are deposited such that the second tube half 11 obtains two substantially straight inner delimiting surfaces 13, 13′ meeting each other at an angle a1 less than 100°.

As indicated in FIG. 4, the steps 110, 120 of successively depositing first and second layers 3, 3′ of the material may comprise the step of:
depositing 122 the first and second layers 3, 3′ of the material in a deposition direction d1,
and wherein the step 120 of successively depositing second layers 3′ of the material comprises the step of:
depositing 124 the second layers 3′ of the material such that the bisection b1 of the angle a1 between the two substantially straight inner delimiting surfaces 13, 13′ is substantially parallel to the deposition direction d1.

Furthermore, as indicated in FIG. 4, the step 122 of depositing the first and second layers 3, 3′ of the material in the deposition direction d1 may comprise the step of:
depositing 126 the first and second layers 3, 3′ of the material in a deposition direction d1 substantially coinciding with a local gravity vector gv.

Furthermore, as indicated in FIG. 4, the step 120 of successively depositing second layers 3′ of the material may comprise the step of:
successively 128 depositing the second layers 3′ of the material such that the angle a1 between the two substantially straight inner delimiting surfaces 13, 13′ is within the range as defined above.

Furthermore, as indicated in FIG. 4, the step 110 of successively depositing first layers 3 of the material may comprise the step of:
successively 112 depositing the first layers 3 of the material such that the first tube half 5 obtains a substantially arc-shaped inner delimiting surface 15.

Furthermore, as indicated in FIG. 4, the steps 110, 120 of successively depositing first and second layers 3, 3′ of the material may comprise the step of:
depositing 129 the first and second layers 3, 3′ of the material such that the first tube portion 7 forms a curved tube portion 7.

Furthermore, as indicated in FIG. 4, the method 100 may further comprise the step of:
successively depositing 130 third layers 3″ of a material such that the deposited third layers 3″ form an inlet portion 17 and an outlet portion 19 each attached to the first tube portion 7.

Furthermore, as indicated in FIG. 4, the step 130 of successively depositing third layers 3″ of the material may comprise the step of:
successively depositing 132 third layers 3″ of the material such that each of the inlet and outlet portion 17, 19 obtains an elliptic, oval, or substantially circular inner delimiting surface 17′, 19′.

Furthermore, as indicated in FIG. 4, the steps 110, 120, 130 of successively depositing first, second, and third layers 3, 3′, 3″ of the material may comprise the step of:
successively depositing 134 first, second, and third layers 3, 3′, 3″ of the material such that the tube 1 obtains a substantially constant effective cross-sectional area A in a flow path 21 from the inlet portion 17 to the outlet portion 19.

Furthermore, as indicated in FIG. 4, the steps 110, 120, 130 of successively depositing first, second, and third layers 3, 3′, 3″ of the material may comprise the step of:
successively depositing 136 layers 3, 3′, 3″ of the material such that the angle a2 between a centre axis C1 of the inlet portion 17 and a centre axis C2 of the outlet portion 19 is within the range of from 0-120 degrees, such as 0-90 degrees or such that the centre axis (C1) of the inlet portion and the centre axis (C2) of the outlet portion are parallel or such that the centre axis (C1) of the inlet portion and the centre axis (C2) of the outlet portion can have any direction in space.

According to the method 100 as described herein, each deposited layer 3, 3′, 3″ of the material may comprise a metallic material.

FIG. 5 schematically illustrates an additive manufacturing machine 50. The additive manufacturing machine 50 comprises a deposition head 32, and motors, such as stepper motors, arranged to change the position of the deposition head 32. The additive manufacturing machine 50 further comprises a control arrangement 35 arranged to control the position of the deposition head 32 and the deposition rate of material deposited from the deposition head 32. The control arrangement 35 comprises a computer 40.

Some embodiments of the present disclosure relate to a computer program comprising instructions which, when the program is executed by a computer 40 of an additive manufacturing machine 50, cause the additive manufacturing machine 50 to carry out the method 100 according to some embodiments described herein. The computer program may thus, when the program is executed by a computer 40 of an additive manufacturing machine 50, cause the additive manufacturing machine 50 to manufacture a tube 1 according to the embodiments illustrated in FIG. 1-FIG. 3, by successively depositing first, second, and third layers 3, 3′, 3″ of a material. It will be appreciated that the various embodiments described for the method 100, with reference to FIG. 4, are all combinable with the control arrangement 35 as described herein. That is, the control arrangement 35 may be configured to perform any one of the method steps 110, 112, 120, 122, 124, 126, 128, 129, 130, 132, 134, and 136 of the method 100.

FIG. 6 illustrates a computer-readable medium 200 comprising instructions which, when executed by a computer 40 of an additive manufacturing machine 50, cause the additive manufacturing machine 50 to carry out the method 100 according to some embodiments.

One skilled in the art will appreciate that the method 100 of manufacturing a tube 1 may be implemented by programmed instructions. These programmed instructions are typically constituted by a computer program, which, when it is executed in control arrangement 35, ensures that the control arrangement 35 carries out the desired control, such as the method steps 110, 112, 120, 122, 124, 126, 128, 129, 130, 132, 134, and 136 described herein. The computer program is usually part of a computer program product 200 which comprises a suitable digital storage medium on which the computer program is stored.

The control arrangement 35 may comprise a calculation unit which may take the form of substantially any suitable type of processor circuit or microcomputer, e.g. a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 35 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

The control arrangement 35 is connected to components of the additive manufacturing machine 50 for receiving and/or sending input and output signals. These input and output signals may comprise waveforms, pulses, or other attributes which the input signal receiving devices can detect as information and which can be converted to signals processable by the control arrangement 35. These signals may then be supplied to the calculation unit. One or more output signal sending devices may be arranged to convert calculation results from the calculation unit to output signals for conveying to other parts of the additive manufacturing machine 50 and/or the component or components for which the signals are intended. Each of the connections to the respective components of the additive manufacturing machine 50 for receiving and sending input and output signals may take the form of one or more from among a cable, a data bus, e.g. a CAN (controller area network) bus, a MOST (media orientated systems transport) bus or some other bus configuration, or a wireless connection.

In the embodiments illustrated, the additive manufacturing machine 50 comprises a control arrangement 35 but might alternatively be implemented wholly or partly in two or more control arrangements or control units.

The computer program product 200 may be provided for instance in the form of a data carrier carrying computer program code for performing at least some of the method steps 110, 112, 120, 122, 124, 126, 128, 129, 130, 132, 134, and 136 according to some embodiments when being loaded into one or more calculation units of the control arrangement 35. The data carrier may be, e.g. a CD ROM disc, as is illustrated in FIG. 6, or a ROM (read-only memory), a PROM (programable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. The computer program product may furthermore be provided as computer program code on a server and may be downloaded to the control arrangement 35 remotely, e.g., over an Internet or an intranet connection, or via other wired or wireless communication systems.

It is to be understood that the foregoing is illustrative of various example embodiments and that the disclosure is defined only by the appended claims. A person skilled in the art will realize that the example embodiments may be modified, and that different features of the example embodiments may be combined to create embodiments other than those described herein, without departing from the scope of the present disclosure, as defined by the appended claims.

As used herein, the term “comprising” or “comprises” is open-ended, and includes one or more stated features, elements, steps, components, or functions but does not preclude the presence or addition of one or more other features, elements, steps, components, functions, or groups thereof.

As understood from the above, according to the method 100, first, second and third layers 3, 3′, 3″ of material are successively deposited onto each other and are joined to each other so as to form a coherent structure. Moreover, according to the method 100, the first, second and third layers 3, 3′, 3″ of material are successively formed and joined to each other so as to form a coherent structure. Therefore, throughout this disclosure, the wording “depositing” may be replaced by the wording “forming”.

The terms “layers” as used herein is intended to mean that one or more layers are printed.

The wording “substantially parallel to”, as used herein, may encompass that the angle between the objects referred to is less than 7 degrees.

The wording “substantially coinciding with”, as used herein, may encompass that the angle between the objects referred to is less than 7 degrees.

The wording “substantially perpendicular to”, as used herein, may encompass that the angle between the objects referred to is within the range of 83-97 degrees.

The wording “substantially straight”, as used herein, may encompass that the object referred to deviates less than 10% from the shape of a flat plane and herein is intended to include slightly curved surfaces, such as a pointed vault or an arch.

The wording “substantially arc-shaped”, as used herein, may encompass that the object referred to deviates less than 10% from the shape of an arc-shaped structure.

The wording “substantially circular”, as used herein, may encompass that the object referred to deviates less than 10% from the shape of a circle.

The wording “substantially constant”, as used herein, may encompass that the aspect referred to varies less than 10%.

The tube 1, as referred to herein, may be manufactured using an additive manufacturing processes within the category vat photopolymerization, stereolithography, material jetting, binder jetting, powder bed fusion, material extrusion, directed energy deposition, selective laser melting/sintering, or sheet lamination. Likewise, the method 100, as referred to herein, may be a manufacturing method within the category vat photopolymerization, stereolithography, material jetting, binder jetting, powder bed fusion, material extrusion, directed energy deposition, selective laser melting/sintering, or sheet lamination.

1. A method of manufacturing a tube, wherein the method comprises the steps of:
successively depositing first layers of a material such that the deposited first layers together form a first tube half of a first tube portion of the tube, and
successively depositing second layers of a material such that the deposited second layers together form a second tube half of the first tube portion,
and wherein the second layers are deposited such that the second tube half obtains two substantially straight inner delimiting surfaces meeting each other at an angle <100°.

2. The method according to claim 1, wherein the steps of successively depositing first and second layers of the material comprises the step of:
depositing the first and second layers of the material in a deposition direction, and
wherein the step of successively depositing second layers of the material comprises the step of:
depositing the second layers of the material such that the bisection of the angle between the two substantially straight inner delimiting surfaces is substantially parallel to the deposition direction.

3. The method according to claim 2, wherein the step of depositing the first and second layers of the material in the deposition direction comprises the step of:
the first and second layers of the material in a deposition direction substantially coinciding with a local gravity vector.

4. The method according to claim 1, wherein the step of successively depositing first layers of the material comprises the step of:
successively depositing the first layers of the material such that the first tube half obtains a substantially arc-shaped inner delimiting surface.

5. The method according to claim 1, wherein the steps of successively depositing first and second layers of the material comprises the step of:
depositing the first and second layers of the material such that the first tube portion forms a curved tube portion.

6. The method according to claim 1, further comprising the step of:
successively depositing third layers of a material such that the deposited third layers form an inlet portion and an outlet portion each attached to the first tube portion.

7. The method according to claim 6, wherein the step of successively depositing third layers of the material comprises the step of:
successively depositing third layers of the material such that each of the inlet and outlet portion obtains an elliptic, oval, or substantially circular inner delimiting surface.

8. The method according to claim 7, wherein the steps of successively depositing first, second, and third layers of the material comprises the step of:
successively depositing first, second, and third layers of the material such that the tube obtains a substantially constant effective cross-sectional area in a flow path from the inlet portion to the outlet portion.

9. The method according to claim 1, wherein each deposited layer of the material comprises a metallic material.

10. A computer program comprising instructions which, when the program is executed by a computer of an additive manufacturing machine, cause the additive manufacturing machine to carry out the method according to claim 1.

11. A computer-readable medium comprising instructions which, when executed by a computer of an additive manufacturing machine, cause the additive manufacturing machine to carry out the method according to claim 1.

12. A tube for conducting a fluid, wherein the tube comprises:
an inlet portion,
an outlet portion, and
a curved tube portion between the inlet and outlet portions,
wherein a vertical cross-section of the curved tube portion comprises two substantially straight inner delimiting surfaces meeting each other at an angle <100°.

13. The tube according to claim 12, wherein the bisection of the angle between the two substantially straight inner delimiting surfaces is substantially parallel to a plane wherein the plane is parallel with the centre axis of the inlet and outlet portions.

14. The tube according to claim 12, wherein the vertical cross-section of the curved tube portion comprises a substantially arc-shaped inner delimiting surface opposite to the two substantially straight inner delimiting surfaces.

15. The tube according to claim 12, wherein the tube is formed by a metallic material.

16. The method according to claim 6, wherein the steps of successively depositing first, second, and third layers of the material comprises the step of:
successively depositing first, second, and third layers of the material such that the tube obtains a substantially constant effective cross-sectional area in a flow path from the inlet portion to the outlet portion.
